(19) United States
(12) Patent Application Publication
(10) Pub. No.: US 2018/0234535 A1
(43) Pub. Date: Aug. 16, 2018

(54) METHOD AND APPARATUS FOR COMMUNICATION

(71) Applicant: MEDIATEK INC., Hsin-Chu City (TW)

(72) Inventors: Tsao-Jiang Chang, Taipei City (TW); Chun-Chuan Chen, Taipei City (TW); Yi-Lun Chen, Changhua City (TW)

(73) Assignee: MEDIATEK INC., Hsin-Chu City (TW)

(21) Appl. No.: 15/870,448

(22) Filed: Jan. 12, 2018

Related U.S. Application Data
(60) Provisional application No. 62/457,197, filed on Feb. 10, 2017.

(51) Int. Cl. H04M 1/725; H04W 88/04; H04L 29/12; G06F 13/38; H04L 12/66

(52) U.S. Cl. CPC H04M 1/72527; H04W 88/04; G06F 2213/3808; G06F 13/385; H04L 12/66; H04L 61/256

(57) ABSTRACT

Aspects of the disclosure provide an electronic device that includes a transceiver circuit, an interface circuit and a modulator-demodulator (modem) circuit. The transceiver circuit is configured to transmit and receive wireless signals to/from a first network that uses a first network address space. The interface circuit is configured to interconnect the electronic device with one or more devices to form a second network using a second network address space. The modem circuit is coupled to the transceiver circuit to modulate/demodulate signals for wireless communication. The modem circuit is configured to provide a packet of a header characteristic for a network address translation between the first network address space and the second network address space, receive, after the network address translation, a modified packet corresponding to the packet, determine a modification associated with the header characteristic and apply the modification to one or more other packets having the header characteristic.

### INCORPORATION BY REFERENCE

This present disclosure claims the benefit of U.S. Provisional Application No. 62/457,197, “Modem Direct Data Path of USB Tethering” filed on Feb. 10, 2017, which is incorporated herein by reference in its entirety.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

A user of a mobile device may want to share the Internet connection of the mobile device with one or more other devices. In an example, a user connects a computer with a mobile phone (e.g., an android phone) via a universal serial bus (USB) cable. The mobile phone is registered in a network. Then, the user can use the computer to access the network via the mobile phone.

### SUMMARY

Aspects of the disclosure provide an electronic device that includes a transceiver circuit, an interface circuit and a modulator-demodulator (modem) circuit. The transceiver circuit is configured to transmit and receive wireless signals to/from a first network that uses a first network address space. The interface circuit is configured to interconnect the electronic device with one or more devices to form a second network using a second network address space. The modem circuit is coupled to the transceiver circuit to modulate/demodulate signals for wireless communication. The modem circuit is configured to provide a packet of a header characteristic for a network address translation between the first network address space and the second network address space, receive, after the network address translation, a modified packet corresponding to the packet, determine a modification associated with the header characteristic and apply the modification to one or more other packets having the header characteristic.

In an embodiment, the electronic device is assigned a first network address in the first network address space for communication in the first network and is assigned a second network address for communication in the second network. In an example, the modem circuit is configured to provide a first uplink packet that is received from the interface circuit for the network address translation, receive a modified first uplink packet corresponding to the first uplink packet, determine a source address change and a source port change in an Internet protocol (IP) header and store the source address change and the source port change associated with the header characteristic.

In another example, the modem circuit is configured to provide a first downlink packet that is received from the transceiver circuit for the network address translation, receive a modified first downlink packet corresponding to the first downlink packet, determine a destination address change and a destination port change in an Internet protocol (IP) header, and store the destination address change and the destination port change associated with the header characteristic.

In an embodiment, the modem circuit is configured to provide the packet of the header characteristic to an application processor for the network address translation. Further, in an example, the modem circuit is configured to receive a tagged packet from the application processor, and receive a tracking of pre-processing and post-processing of the tagged packet to determine the modification by the application processor. In another example, the modem circuit is configured to tag the packet before the network address translation and receive a modified packet corresponding to the tagged packet after the network address translation.

In an example, the interface circuit is configured according to a universal serial bus (USB) standard. In another example, the interface circuit is configured according to a WiFi standard.

In an embodiment, the modem circuit includes a processing circuit configured to perform the network address translation.

Aspects of the disclosure provide a method for communication. The method includes receiving, by a modulator-demodulator (modem) circuit in an electronic device, a packet of a header characteristic for transmission between a first network using a first network address space and a second network using a second address space. The electronic device includes a transceiver circuit that is coupled to the first network, and an interface circuit that is coupled to the second network. The method further includes performing a network address translation on the packet for routing the packet, determining a modification on the packet due to the network address translation, and applying the modification to one or more other packets having the header characteristic.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a block diagram of a communication system 100 according to an embodiment of the disclosure;

FIG. 2 shows a block diagram of an electronic device 210 handling uplink communication according to an embodiment of the disclosure;

FIG. 3 shows a flow chart outlining a process 300 for handling uplink communication according to an embodiment of the disclosure;

FIG. 4 shows a block diagram of a mobile device 410 handling downlink communication according to an embodiment of the disclosure; and

FIG. 5 shows a flow chart outlining a process 500 for handling downlink communication according to an embodiment of the disclosure.

### DETAILED DESCRIPTION OF EMBODIMENTS

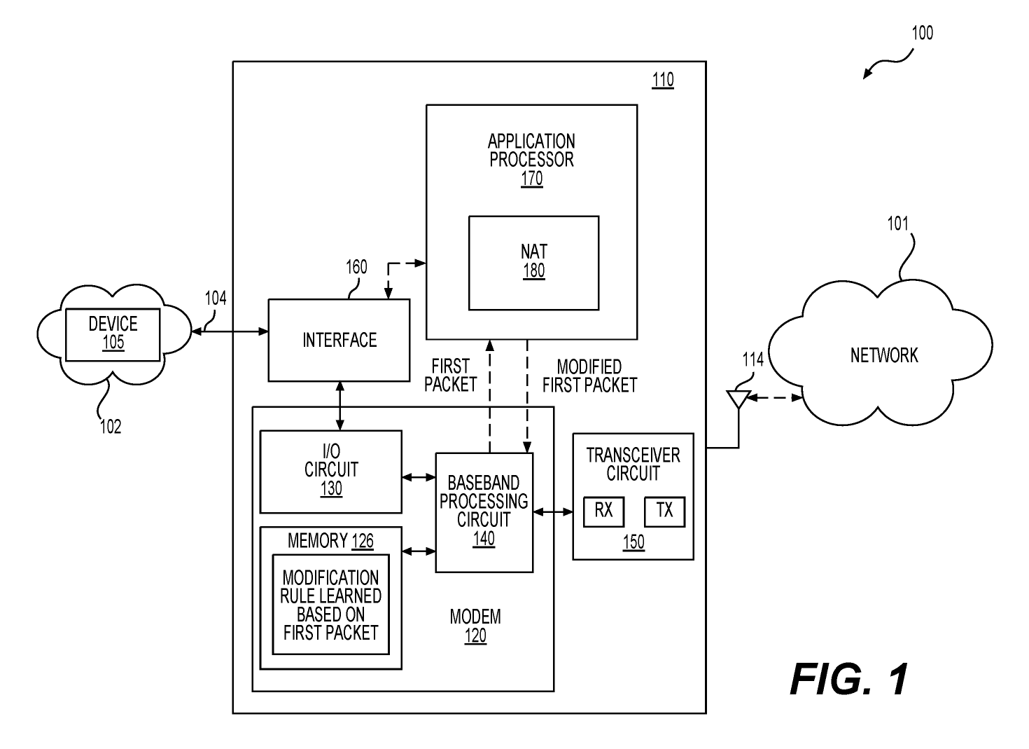

FIG. 1 shows a block diagram of a communication system 100 according to an embodiment of the disclosure. The communication system 100 includes an electronic device 110 that interfaces a first network 101 and a second network 102 using different network addresses. The electronic device 110 is configured to perform network address translation to route communication flow from one network to the other network.

Specifically, in the FIG. 1 example, the electronic device 110 includes a cellular modulator-demodulator (modem) circuit 120 coupled to a transceiver circuit 150 that air-interfaces the electronic device 110 with the first network 101. Further, the electronic device 110 includes an interface 160 that interfaces the electronic device 110 with the second network 102. The electronic device 110 includes additional processing circuitry, such as an application processor 170 to support an operation environment and execution of applications in the electronic device 110.

According to an aspect of the disclosure, the cellular modem circuit 120 is configured to perform network address translation for packets and route the packets between the two networks 101 and 102. In an embodiment, the cellular modem circuit 120 is configured to learn a modification rule based on a first packet that is processed (e.g., with network address translation) by other processing circuitry, such as the application processor 170. Thus, the cellular modem circuit 120 can apply the modification rule to other packets with same header characteristic as the first packet without providing the other packets to the application processor 170.

The two networks 101 and 102 can be any suitable networks in which the electronic device 110 is recognized respectively using different network addresses. In an embodiment, the first network 101 is a wide area network (WAN), the electronic device 110 is assigned, for example by an Internet service provider (ISP), a first Internet protocol (IP) address. The electronic device 110 can be recognizable in the first network 101 using the first IP address. In an example, the first IP address is a public IP address that is selected from a pool of public IP addresses of the ISP. The public IP address is a unique IP address that can be accessed over the Internet in an example. For example, the Internet can transmit a packet to the electronic device 110 when a destination IP address field of the packet has the first IP address. It is noted that the first IP address can change for example in a scenario that the electronic device 110 is disconnected from the first network 101 and is then reconnected in the first network 101.

In an embodiment, the second network 102 is a local area network (LAN), such as private network, home network, office network and the like. The electronic device 110 is recognized by a second IP address in the local area network. In an example, the second IP address is a private IP address. The private IP address is a non-Internet IP address for internal use in the private network 102. It is noted that the second IP address can be assigned to another device in another local area network.

According to an aspect of the disclosure, the electronic device 110 is connected in the first network 101 via a telecommunication service. In an example, the first network 101 includes a wireless telecommunication service provider that provides wireless telecommunication service using any suitable wireless communication technology, such as second generation (2G) mobile network technology, third generation (3G) mobile network technology, fourth generation (4G) mobile network technology, fifth generation (5G) mobile network technology, and the like.

In an example, a wireless telecommunication service provider is a facility-based provider that owns the mobile infrastructure (including both hardware and software), such as cell towers, network components that form a backbone to manage and control the services provided by the wireless telecommunication service provider. In another example, a wireless telecommunication service provider is a mobile virtual network operator that does not own a mobile infrastructure, but leases telephone and data service from facility-based providers.

The electronic device 110 can be any suitable electronic device. In an example, the electronic device 110 is a terminal device used by an end-user for mobile telecommunication, such as a cell phone, a smart phone, a tablet computer, and the like. According to an aspect of the disclosure, the electronic device 110 can execute suitable software, such as tethering application and the like, to establish a tethering link 104 via the interface 160 with one or more devices in the second network 102. In the FIG. 1 example, the electronic device 110 establishes the tethering link 104 with a device 105, such as a personal computer, a laptop computer, a tablet computer, a smart phone, and the like.

The tethering link 104 can be any suitably link. In an embodiment, the interface 160 is mechanically and electrically configured according to a universal serial bus (USB) standard, thus the interface 160 is a suitable USB connector or USB port. In an example, a USB cable has a first plug plugged in the interface 160 and a second plug plugged in a USB receptacle of the device 105 to connect the electronic device 110 and the device 105, thus the tethering link 104 is a wired USB link.

In another embodiment, the interface 160 includes a WiFi transceiver that is configured to receive and transmit wireless signals according to suitable wireless standard, such as various IEEE 802.11 standards. The device 105 includes suitable circuitry, such as a WiFi transceiver (not shown) and that is configured to receive and transmit wireless signals according to suitable wireless standard, such as various IEEE 802.11 standards. Thus, the electronic device 110 and the device 105 can setup the tethering link 104 according to the IEEE 802.11 standards, thus the tethering link 104 is a WiFi wireless link.

It is noted that other suitably technology, such as FireWire technology, Bluetooth technology, and the like can be used to setup a wired communication link or a wireless communication link between the electronic device 110 and the device 105.

In an example, the electronic device 110 is installed with software instructions (e.g., an app for tethering) for setting up the tethering link 104. In an example, when the electronic device 110 executes the software instructions, and communicates with the device 105 to setup the tethering link 104, the second IP address (e.g., private IP address) is assigned to the electronic device 110 (e.g., the interface 160) and another IP address (e.g., private IP address, also referred to as a third IP address) is assigned to the device 105. The electronic device 110 and the device 105 form the second network 102. The electronic device 110 is known in the second network 102 by the second IP address, and the device 105 is known in the second network 102 by the third IP address. Then, the device 105 is a tethering device that can access Internet via the electronic device 110. The electronic device 110 then routes tethering communication traffic between the device 105 and the Internet. For example, the device 105 can send uplink packets to the first network 101 via the electronic device 110 and can receive downlink packets from the first network 101 via the electronic device 110.

According to an aspect of the disclosure, the electronic device 110 is configured to perform network address translation on the downlink packets to the device 105 and perform network address translation on the uplink packets from the device 105. In an example, when the electronic device 110 receives an uplink packet from the device 105 to the Internet, the electronic device 110 modifies certain header fields in the IP header of the uplink packet. For example, the electronic device 110 modifies a source IP address field (e.g., a change from the third IP address to the first IP address), and other suitable fields, such as a source port field in the uplink packet, before transmits the uplink packet to the first network 101 (e.g., the Internet). Thus, in an example, when the uplink packet arrives at a destination device (not shown) in the Internet, the destination device recognizes the first IP address in the source IP address field. Further, in an example, when a downlink packet is generated for example by the destination device in response to the uplink packet, the destination device can fill the first IP address in a destination IP address field of the downlink packet. Then, the downlink packet is transmitted in the Internet and arrives at the electronic device 110. In the example, when the electronic device 110 receives the downlink packet, the electronic device 110 determines that the downlink packet is for the device 105 for example based on fields in the IP header of the downlink packet, and the electronic device 110 modifies, for example, the destination IP address field (e.g., a change from the first IP address to the third IP address), and other suitable fields, such as a destination port field in the downlink packet before sends the downlink packet in the second network 102.

It is noted that in an example, when the application processor 170 executes a tethering application, the application processor 170 is able to perform the network address translation. Further, according to an embodiment of the disclosure, the cellular modem circuit 120 is configured to learn a modification associated with a header characteristic based on a packet (referred to as a first packet) that is processed by other circuitry, such as the application processor 170, and then use the modification on other packets that have the same header characteristic as the first packet.

In an example, the cellular modem circuit 120 maintains a database (e.g., a lookup table) of modification rules that associate modifications with header characteristics. When the cellular modem circuit 120 receives a first packet, the cellular modem circuit 120 determines the specific header characteristic of the first packet. When a modification rule with matching header characteristic to the specific header characteristic does not exist in the database, in an example, the cellular modem circuit 120 provides the first packet to the application processor 170. The application processor 170 can route the first packet. Specifically, the application processor 170 performs network address translation on the first packet to generate a modified first packet corresponding to the first packet, and sends the modified first packet to the cellular modem circuit 120. The cellular modem circuit 120 receives the modified first packet corresponding to the first packet from the application processor 170. The cellular modem circuit 120 compares the modified first packet with the first packet to determine a modification, and stores the modification associated with the specific header characteristic of the first packet in the database.

Further in the example, when the cellular modem circuit 120 receives a second packet with the same specific header characteristic, the cellular modem circuit 120 applies the modification associated with the specific header characteristic on the second packet. In the example, the application processor 170 is not involved in the modification for the second packet.

In some embodiments, the application processor 170 is a powerful processor that is configured to provide an operating environment and support various applications, such as memory management, graphics processing, multimedia decoding, network address translation (NAT), and the like. In the FIG. 1 example, the application processor 170 can execute software instructions 180 to perform network address translation.

In an example, the application processor 170 is implemented as a system on chip (SOC) with multiple processing cores on a chip. In the example, the application processor 170 consumes a relatively large amount of electrical power during operation. In an embodiment, the electronic device 110 is a battery powered device, and the application processor 170 is configured to enter a power saving mode to save power when the application processor 170 is not in use during operation to extend battery usage time before next charging. In the embodiment, when the cellular modem circuit 120 performs modification to packets without waking up the application processor 170, the application processor 170 can stay in the power saving mode for longer time to reduce power consumption.

Specifically, in the FIG. 1 example, the cellular modem circuit 120 includes a baseband processing circuit 140, an input/output (I/O) circuit 130, and a memory circuit 126 coupled together as shown in FIG. 1. The baseband processing circuit 140 is coupled to the transceiver circuit 150 that air-interfaces the electronic device 110 with the first network 101.

The transceiver circuit 150 is configured to receive and transmit wireless signals. In an example, transceiver circuit 150 includes a receiving circuit (RX) and a transmitting circuit (TX). The receiving circuit RX is configured to generate electrical signals in response to captured electromagnetic waves by an antenna 114, process the electrical signals to extract digital streams from the electrical signals. In an example, the transmitting circuit is configured to receive digital streams corresponding to management frames, data frames, and the like from the baseband processing circuit 140, generate radio frequency (RF) signals to carry the digital streams, and emit electromagnetic waves in the air via the antenna 114 to transmit wireless signals that carry the digital streams.

The I/O circuit 130 is electrically connected to the interface 160. In an example, the I/O circuit 130 provides control signals, such as an interrupt signal, and the like to the interface 160. In an example, the interface 160 is selectively coupled to one of multiple components in the electronic device 110, such as the cellular modem circuit 120, the application processor 170 and the like. For example, the interface 160 includes registers (not shown) that are used to configure operations of the interface 160. In an example, when the electronic device 110 is connected to the first network 101 via the cellular modem circuit 120 and the transceiver circuit 150, the interface 160 is coupled to the cellular modem circuit 120; otherwise, the interface 160 is coupled to the application processor 170 in an example. When the interface 160 is coupled to the cellular modem circuit 120, the cellular modem circuit 120 can access the registers in the interface 160 to control the operations of the interface 160. For example, the cellular modem circuit 120 can send interrupt signals to the interface 160 and can change the registers in the interface 160. Further, in an example, the interface 160 can provide uplink packets in suitable form to the cellular modem circuit 120 via the I/O circuit 130, and the I/O circuit 130 can provide downlink packets in suitable form to the interface 160 for sending to the second network 102.

It is noted that the I/O circuit 130 can be directly coupled to the interface 160 or can be coupled to the interface 160 via for example a hub (e.g., USB hub).

The memory circuit 126 is configured to store a database of modification rules that are learned based on packets being processed by the application processor 170 for example. In an example, the database includes a lookup table of modification rules. In an example, a modification rule includes a modification associated with a header characteristic. The database includes a first modification rule for a flow of uplink packets and a second modification rule for a flow of downlink packets in an example. The first modification rule includes a first modification associated with a first header characteristic, and the second modification rule includes a second modification associated with a second header characteristic.

In an example, the first header characteristic includes characteristics for identifying the uplink packets in a same flow. Generally, a flow of packets refers to a sequence of packets from a same source (e.g., an application running in a source device) to a same destination (e.g., an application running in a destination device). In an example, the flow of uplink packets has identical values in certain fields in the IP header, such as the source IP address field, the source port field, the destination IP address field, the destination port field and the like. In an example, the first header characteristic indicates values in the certain fields of the IP header, such as the source IP address field, the source port field, the destination IP address field, the destination port field, and the like. For example, the first header characteristic indicates that the uplink packets in the flow have the third IP address in the source IP address field. The first modification specifies changes to fields in the IP header, such as the source IP address field, the source port field and the like of the uplink packet. For example, the first modification includes a replacement of the source IP address field of the uplink packet with the first IP address.

In another example, the second header characteristic indicates characteristics for identifying the downlink packets in a same flow. In an example, the second header characteristic indicates values in certain fields of the IP header, such as the destination IP address field, the destination port field, the source IP address field, the source port field, and the like. For example, the second header characteristic indicates that the downlink packet has the first IP address in the destination IP address field. The second modification specifies changes to the IP header fields, such as the destination IP address field, the destination port field and the like of the downlink packet. For example, the second modification includes a replacement of the destination IP address field of the downlink packet with the third IP address.

In an example, the baseband processing circuit 140 is configured to perform various functions for digital signal processing in baseband. In an example, the baseband processing circuit 140 modulates digital signals into a form that is suitable for RF transmission by the transmitting circuit TX in the transceiver circuit 150. In another example, the baseband processing circuit 140 demodulates down-converted digital stream in baseband to recover information content, such as management frames, data frames. Additionally, the baseband processing circuit 140 processes the information content based on suitable protocols, such as a stack of protocols, such as media access control (MAC) layer protocol, IP layer protocol, and the like. In an example, the baseband processing circuit 140 performs network address translation in the IP layer protocol for uplink packets and downlink packets.

During operation, in an example, when the electronic device 110 is connected in the first network 101 via a wireless telecommunication service provider, a first IP address (e.g., 2.2.2.2) which is a public IP address is assigned to the first electronic device 110 for access over the Internet in an example. The electronic device 110 uses a first port (e.g., port 3) for cellular communication in an example.

Further, in the example, a tethering application is installed and executed by the application processor 170. When the device 105 is coupled to the electronic device 110 via the interface 160, the tethering link 104 is established. The electronic device 110 is assigned a second IP address (e.g., 1.1.1.2), and the device 105 is assigned a third IP address (e.g., 1.1.1.1) for use in the second network 102. In an example, the electronic device uses a second port (e.g., port 2) for the tethering link 104 and the device 105 uses a third port (e.g., port 1) for the tethering link 104.

In an example, the device 105 executes an application and generates a first uplink packet that is destined to a specific device (not shown) in the first network 101. The specific device has a fourth IP address (e.g., 2.2.2.3) that is a public IP address in an example, and uses a forth port (e.g., port 4) in the communication with the device 105. In the first uplink packet, the source IP address field has the third IP address (e.g., 1.1.1.1), the source port field has the third port (e.g., port 1), the destination IP address field has the fourth IP address (e.g., 2.2.2.3), and the destination port field has the fourth port (e.g., port 4).

In the example, the device 105 sends the first uplink packet to the electronic device 110 via the tethering link 104. The cellular modem circuit 120 receives the first uplink packet. The baseband processing circuit 140 determines a first header characteristic of the first uplink packet, such as the third IP address (e.g., 1.1.1.1) in the source IP address field. The baseband processing circuit 140 searches a lookup table of modification rules for a matching entry with the first header characteristic. When the baseband processing circuit 140 fails to find, in the lookup table, a matching entry with the first header characteristic, the baseband processing circuit 140 provides the first uplink packet to the application processor 170.

The application processor 170 performs routing and network address translation on the first uplink packet to generate a modified first uplink packet. For example, the application processor 170 replaces the source IP address field with the first IP address (e.g., 2.2.2.2), and replaces the source port field with the first port (e.g., port 3). The application processor 170 provides the modified first uplink packet to the cellular modem circuit 120.

When the cellular modem circuit 120 receives the modified first uplink packet, the baseband processing circuit 140 compares the modified first uplink packet with the first uplink packet to determine first modification, such as the source IP address change, the source port change, and the like. The baseband processing circuit 140 stores a first modification rule that associates the first modification with the first header characteristic. The transmitting circuit TX transmits wireless signals carrying the modified first uplink packet in the first network 101. The modified first uplink packet arrives at the specific device in the first network 101.

In an embodiment, the specific device in the network 101 generates a first downlink packet in response to the modified first uplink packet. In the first downlink packet, the source IP address field has the fourth IP address (e.g., 2.2.2.3), and the source port field has the fourth port (e.g., port 4). Further, in the example, the destination information of the first downlink packet is provided based on the source information of the modified first uplink packet. For example, the destination IP address field of the first downlink packet has the first IP address (e.g., 2.2.2.2), and the destination port field has the first port (e.g., port 3).

In the example, the specific device sends the first downlink packet in the first network 101. The first downlink packet is routed to the electronic device 110 based on the destination information. The transceiver circuit 150 generates electrical signals in response to captured electromagnetic waves that carry the first downlink packet, processes the electrical signals to extract digital streams from the electrical signals. The cellular modem circuit 120 receives the digital streams and demodulates the digital streams to reconstruct the first downlink packet. The baseband processing circuit 140 determines a second header characteristic of the first downlink packet, such as the first IP address (e.g., 2.2.2.2) in the destination IP address field and the like. The baseband processing circuit 140 searches the lookup table, for a modification rule with matching header characteristic to the second header characteristic. When the baseband processing circuit 140 fails to find the modification rule with the matching header characteristic in the lookup table, the baseband processing circuit 140 provides the first downlink packet to the application processor 170.

The application processor 170 performs routing and network address translation on the first downlink packet to generate a modified first downlink packet. For example, the application processor 170 replaces the destination IP address field with the third IP address (e.g., 1.1.1.1), and replaces the destination port field with the third port (e.g., port 1). The application processor 170 provides the modified first downlink packet to the cellular modem circuit 120.

When the cellular modem circuit 120 receives the modified first downlink packet, the baseband processing circuit 140 compares the modified first downlink packet with the first downlink packet to determine second modification, such as the destination address change, the destination port change, and the like. The baseband processing circuit 140 stores a second modification rule that associates the second modification with the second header characteristic. Then, the modified first downlink packet is output to the interface 160. The interface 160 sends the modified first downlink packet to the device 105 via the tethering link 104.

In an example, the device 105 generates, in the application, a second uplink packet that is destined to the specific device (not shown) in the network 101. The second uplink packet is in a same flow as the first uplink packet. Similar to the first uplink packet, the source IP address field in the second uplink packet has the third IP address (e.g., 1.1.1.1), the source port field in the second uplink packet has the third port (e.g., port 1), the destination IP address field in the second uplink packet has the fourth IP address (e.g., 2.2.2.3), and the destination port field in the second uplink packet has the fourth port (e.g., port 4).

In the example, the device 105 sends the second uplink packet to the electronic device 110 via the tethering link 104. The cellular modem circuit 120 receives the second uplink packet. The baseband processing circuit 140 determines a third header characteristic of the second uplink packet that is the same as the first header characteristic. The baseband processing circuit 140 searches the lookup table, looks for a modification rule with matching header characteristic to the third header characteristic. When the baseband processing circuit 140 finds that the first header characteristic of the first modification rule matches the third header characteristic, the baseband processing circuit 140 applies the first modification to the second uplink packet to generate a modified second uplink packet. For example, the baseband processing circuit 140 replaces the source IP address field with the first IP address (e.g., 2.2.2.2), and replaces the source port field with the first port (e.g., port 3). The transmitting circuit TX transmits wireless signals carrying the modified second uplink packet in the first network 101. The modified second uplink packet is routed in the first network 101 and arrives at the specific device in the first network 101.

In an example, the specific device in the first network 101 generates a second downlink packet in response to the modified second uplink packet, and the second downlink packet is in the same flow as the first downlink packet. In an example, in the second downlink packet, the source IP address field has the fourth IP address (e.g., 2.2.2.3), the source port field has the fourth port (e.g., port 4), the destination IP address field has the first IP address (e.g., 2.2.2.2), and the destination port field has the first port (e.g., port 3).

In the example, the specific device sends the second downlink packet in the first network 101. The second downlink packet is routed to the electronic device 110 based on the destination information, such as the destination IP address, and the like in the second downlink packet. The transceiver circuit 150 generates electrical signals in response to captured electromagnetic waves that carry the second downlink packet, processes the electrical signals to extract digital streams from the electrical signals. The cellular modem circuit 120 receives the digital streams and demodulates the digital streams to reconstruct the second downlink packet. The baseband processing circuit 140 determines a fourth header characteristic of the second downlink packet. The baseband processing circuit 140 searches the lookup table and looks for a modification rule with matching header characteristic to the fourth header characteristic. When the baseband processing circuit 140 finds that the second modification rule has matching header characteristic to the fourth header characteristic, the baseband processing circuit 140 applies the second modification of the second modification rule to the second downlink packet to generate a modified second downlink packet. For example, the baseband processing circuit 140 replaces the destination IP address field of the second downlink packet with the third IP address (e.g., 1.1.1.1), and replaces the source port field of the second downlink packet with the third port (e.g., port 1). Then, the modified second downlink packet is output by the I/O circuit 130 to the interface 160. The interface 160 sends the modified second downlink packet to the device 105 via the tethering link 104.

It is noted that the components in the electronic device 110 can be integrated by various techniques. In an example, the cellular modem circuit 120 is implemented on an IC chip. In another example, the transceiver circuit 120 and the cellular modem circuit 120 are integrated on an IC chip. In another example, the application processor 170 and cellular modem circuit 120 are integrated on a system on chip (SOC). In another example, the modification rules are stored in a memory circuit (not shown) that is external of the cellular modem circuit 120.

It is also noted that the baseband processing circuit 140 can perform other suitable operations on packets. For example, according to the IP layer protocol, after the IP address and port modification, the baseband processing circuit 140 calculates cyclical redundancy check (CRC) codes, such as invariant CRC, variant CRC, and the like, and includes the CRC codes in the packets. In another example, the baseband processing circuit 140 performs operations according to suitable MAC layer protocol on a packet to encapsulate the packet in a frame, or de-capsulate a frame to generate a packet.

While, in the above description, various operations are described in term of packets. It is noted that, in an example, the operations are performed on packet descriptors. A packet descriptor for a packet includes for example, the header information of the packet, and/or information generated during packet processing, such as tags, flags, indicators and the like. For ease of explanation, the term “packet” herein is used to refer to a packet itself or to a packet descriptor associated with the packet.

In an example, the cellular modem circuit 120 tags a packet before sends the packet to the application processor 170. The application processor 170 removes the tag when the application processor 170 determines that routing and/or network address translation processing on packets in the same flow as the packet is not forwarded to the cellular modem circuit 120; otherwise, the tag is kept. When the cellular modem circuit 120 receives a modified packet with the tag, the cellular modem circuit 120 determines the modification on the packet and determines a modification rule.

In another example, when the application processor 170 receives a packet from the cellular modem circuit 120, the application processor 170 determines whether routing and/or network address translation processing on packets in the same flow as the packet is forwarded to the cellular modem circuit 120. When the routing and/or network address translation processing on packets in the same flow as the packet is forwarded to the cellular modem circuit 120, the application processor 170 tags a modified packet corresponding to the packet. When the cellular modem circuit 120 receives the modified packet with the tag, the cellular modem circuit 120 determines the modification on the packet and determines a modification rule.

It is noted that, in an embodiment, the cellular modem circuit 120 includes another processing circuit (not shown) configured to perform routing and NAT on the first packet. Thus, the first packet is modified within the cellular modem circuit 120 by the other processing circuit. The baseband processing circuit 140 can learn the modification rule based on the modified first packet, and store the modification rule for applying to other packets directly.

In another embodiment, the application processor 170 generates a pre-routing packet descriptor and a post-routing packet descriptor for modified packet, and provides the pre-routing packet descriptor and the post-routing packet descriptor to the cellular modem circuit 120. The cellular modem circuit 120 determines modification on the packet based on the pre-routing packet descriptor and the post-routing packet descriptor.

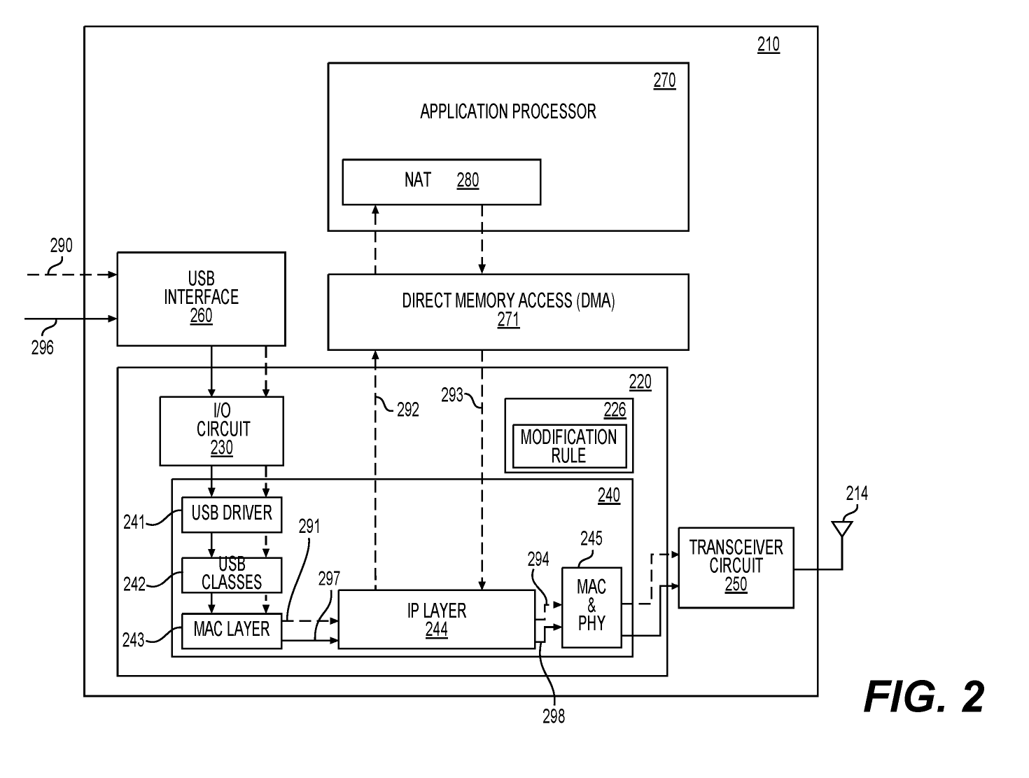

FIG. 2 shows a block diagram of an electronic device 210 for handling uplink communication according to an embodiment of the disclosure. The electronic device 210 operates similarly to electronic device 110 described above for uplink communication. In an example, the electronic device 210 can be used in the place of the electronic device 110 in the FIG. 1 example. The electronic device 210 also utilizes certain components that are identical or equivalent to those used in electronic device 110; the description of these components has been provided above and will be omitted here for clarity purposes. However, in the FIG. 2 example, the interface 260 is a USB interface 260, and the baseband processing circuit 240 is configured specifically to control the USB interface 260. Further, in the FIG. 2 example, the electronic device 210 uses a system memory (not shown) to store packet information, such as packets, packet descriptors, and includes direct memory access (DMA) circuit 271 to allow the application processor 270 and the cellular modem circuit 220 to access the system memory.

Specifically, in the FIG. 2 example, the baseband processing circuit 240 executes certain software instructions, such as software instructions of a USB driver 241, software instructions of USB classes 242, software instructions of MAC layer protocol 243, software instruction of IP layer protocol 244, and the like, to perform specific functions. For example, the baseband processing circuit 240 executes software instructions of the USB driver 241 to control the USB interface 260. The USB driver 241 provides a software interface to hardware, such as the USB interface 260 to enable the operating system and other computer program to access the hardware functions without detail knowledge of the hardware being used.

Further, in the FIG. 2 example, the baseband processing circuit 240 executes software instructions of the USB classes 242. The USB classes 242 include USB based program-code-templates for object-oriented programming. The USB classes 242 provide an interface between signals in USB format and frames in MAC layer. For example, the USB classes 242 can be used to convert signals received from USB interface 260 in the USB format to frames in MAC layer, and can be used to convert frames in MAC layer to the USB format that is suitable for the USB interface 260.

Further, in the FIG. 2 example, the baseband processing circuit 240 executes software instructions of the MAC layer protocol 243. In an example, the MAC layer protocol 243 performs operations in the MAC layer. For example, when a frame is received, the MAC layer protocol 243 can parse the frame, perform error detection, and extract a packet in the IP layer. In another example, the MAC layer protocol 243 can encapsulate a packet in a frame before transmission.

Further, in the FIG. 2 example, the baseband processing circuit 240 executes the software instructions of the IP layer protocol 244. The IP layer protocol 244 can route packets and perform network address translation. In an example, the IP layer protocol 244 can determine whether a modification rule exists in the memory 260 for a packet. When the modification rule does not exist, the IP layer protocol 244 can provide the packet to the application processor 270 for processing. When the modification rule exists, the IP layer protocol 244 can apply modification on the packet according to the modification rule.

In the FIG. 2 example, the baseband processing circuit 240 also includes other suitable hardware and/or software, such as modules 245 for MAC layer, physical (PHY) layer, modulation/demodulation, and the like.

During operation, in an example, the USB interface 260 receives signals 290 carrying a first uplink packet. The USB interface 260 provides the received signals to the cellular modem circuit 220 via the I/O circuit 230. The baseband processing circuit 240 executes functions corresponding to the USB driver 241, the USB classes 242 and the MAC layer protocol operation 243 to reconstruct the first uplink packet 291. The baseband processing circuit 240 then performs the IP layer protocol 244 on the first uplink packet 291.

In an embodiment, the baseband processing circuit 240 extracts a first header characteristic of the first uplink packet 291, searches a lookup table of modification rules for a modification rule with matching header characteristic to the first header characteristic. When the baseband processing circuit 240 fails to find, in the lookup table, a modification rule with matching header characteristic, the baseband processing circuit 240 provides the first uplink packet 291 to the application processor 270 via the DMA circuit 271.

The application processor 270 performs routing and network address translation on the first uplink packet to generate a modified first uplink packet. For example, the application processor 270 changes the source IP address field, and the source port field. The application processor 270 provides the modified first uplink packet 293 to the cellular modem circuit 220 via the DMA circuit 271.

When the cellular modem circuit 220 receives the modified first uplink packet, the baseband processing circuit 240 compares the modified first uplink packet with the first uplink packet to determine first modification, such as the source IP address change, the source port change, and the like. The baseband processing circuit 240 stores a first modification rule that associates the first modification with the first header characteristic. The modified first uplink packet is further processed. For example, the modulated first uplink packet is encapsulated in a frame, and then is modulated into suitable form for transmission. The transceiver circuit 250 then transmits wireless signals carrying the modified first uplink packet.

Further, in the FIG. 2 example, the USB interface 260 receives signals 296 carrying a second uplink packet. The USB interface 260 provides the received signals to the cellular modem circuit 220 via the I/O circuit 230. The baseband processing circuit 240 executes functions corresponding to the USB driver 241, the USB classes 242 and the MAC layer protocol operation 243 to reconstruct the second uplink packet 297. The baseband processing circuit 240 then performs the IP layer operation 244 on the second uplink packet 297.

In an embodiment, the baseband processing circuit 240 extracts a second header characteristic of the second uplink packet 297, searches the lookup table of modification rules for a modification rule with matching header characteristic to the second header characteristic. When the baseband processing circuit 240 finds that the first modification rule has matching header characteristic to the second header characteristic, the baseband processing circuit 240 applies the firsts modification on the second uplink packet 297 to generate a modified second uplink packet 298. The modified second uplink packet is further processed. For example, the modulated second uplink packet is encapsulated in a frame, and then is modulated into suitable form for transmission. The transceiver circuit 250 then transmits wireless signals carrying the modified first uplink packet.

In the FIG. 2 example, the second uplink packet is directly routed with NAT by the cellular modem circuit 220. In an example, the application processor 270 can stay in the power saving mode, and does not need to wake up to process the second uplink packet.

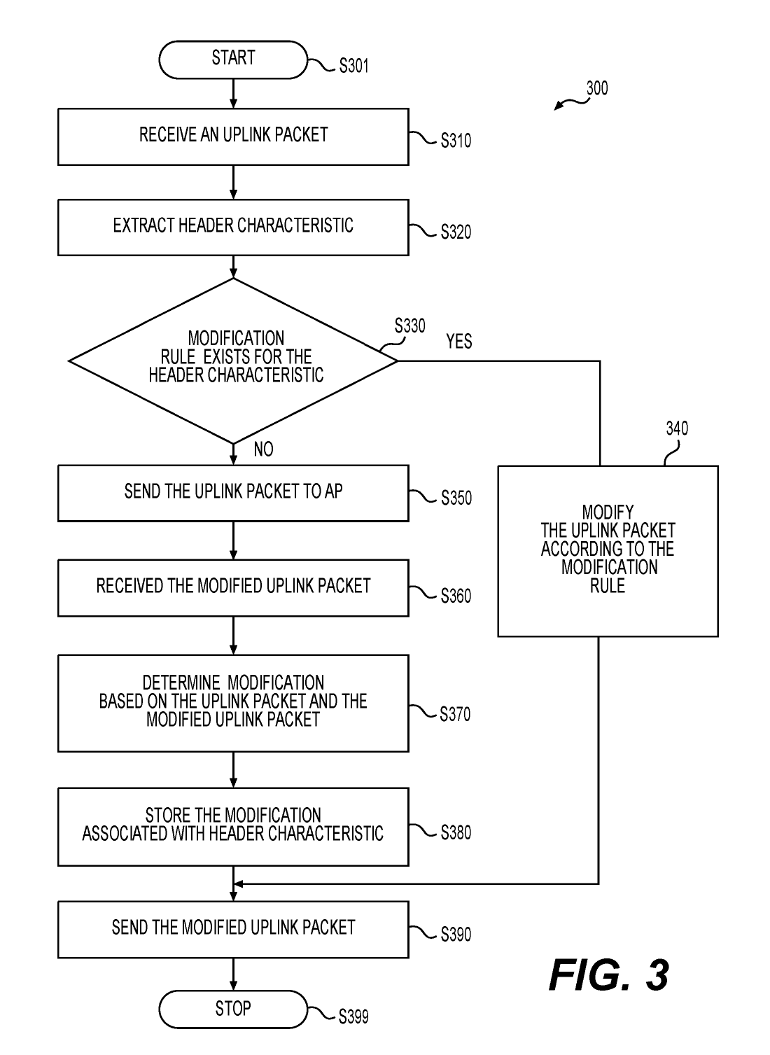

FIG. 3 shows a flow chart outlining a process 300 for handling uplink packets according to an embodiment of the disclosure. In an example, the process 300 is executed by the electronic device 210 in the FIG. 2 example. The process starts at S301, and proceeds to S310.

At S310, an uplink packet is received. In an example, the baseband processing circuit 240 reconstructs the uplink packet from signals received from the USB interface 260.

At S320, a header characteristic is extracted. In an example, the baseband processing circuit 240 parses the uplink packet to extract, for example, one or more of the source IP address field, the source port field, the destination IP address field, the destination port field and the like.

At S330, the baseband processing circuit 240 determines whether a modification rule exists for the header characteristic. When the modification rule exists, the process proceeds to S340; otherwise, the process proceeds to S350.

At S340, the uplink packet is modified according to the modification rule. For example, the modification rule includes a modification associated with the header characteristic. The baseband processing circuit 240 applies the modification to the uplink packet to generate the modified uplink packet.

At S350, the uplink packet is provided to another processing unit, such as the application processor 270. In an example, the application processor 270 performs routing and network address translation on the uplink packet to generate a modified uplink packet.

At S360, the modified uplink packet is received. In an example, the application processor 270 provides the modified uplink packet to the baseband processing circuit 240.

At S370, a modification is determined based on the uplink packet and the modified uplink packet. In an example, the baseband processing circuit 240 compares the uplink packet and the modified uplink packet to determine changes, such as IP address change, port change, and the like from the uplink packet and the modified uplink packet.

At S380, the modification is stored in association with the header characteristic. In an example, the baseband processing circuit 240 stores a modification rule that associates the modification with the header characteristic in a look-up table.

At S390, the modified uplink packet is transmitted. For example, the modulated uplink packet is encapsulated in a frame, and then is modulated into suitable form for transmission. The transceiver circuit 250 then transmits wireless signals carrying the modified uplink packet. Then, the process proceeds to S399 and terminates.

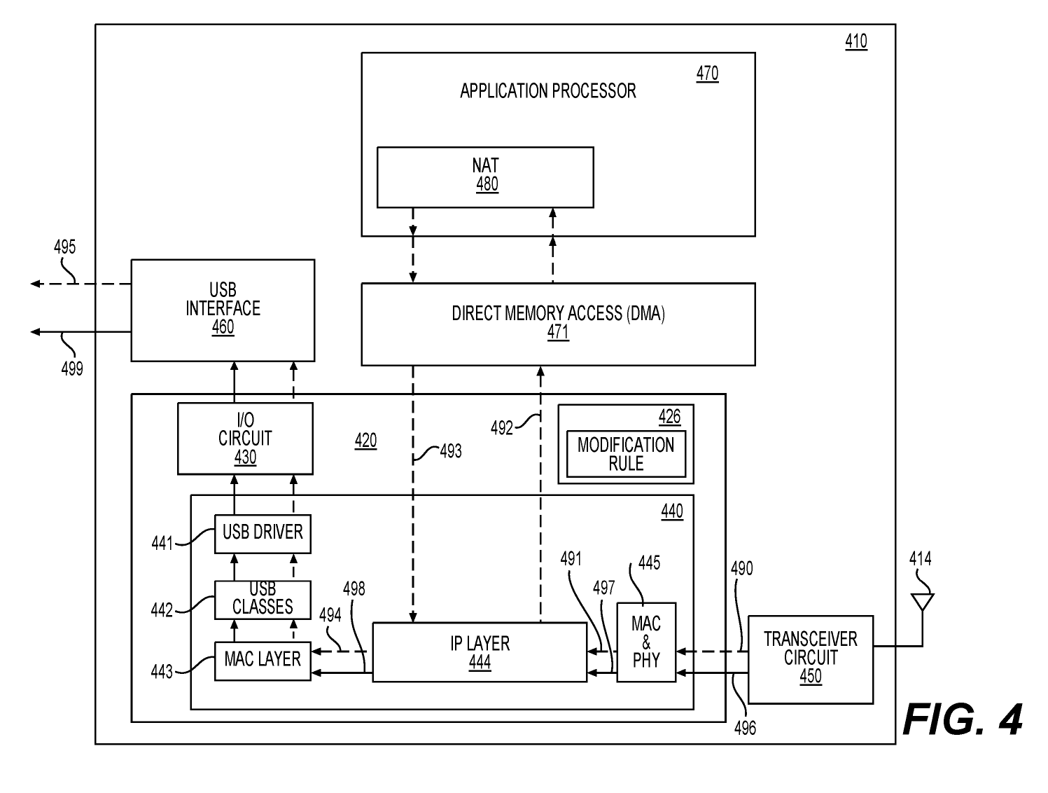

FIG. 4 shows a block diagram of an electronic device 410 handling downlink communication according to an embodiment of the disclosure. The electronic device 410 operates similarly to electronic device 110 described above. In an example, the electronic device 410 can be used in the place of the electronic device 110 in the FIG. 1 example for handling downlink communication. The electronic device 410 utilizes certain components that are identical or equivalent to those used in electronic device 210; the description of these components has been provided above and will be omitted here for clarity purposes.

During operation, in an example, the transceiver circuit 450 receives signals carrying a first downlink packet. The transceiver circuit 450 provides a digital stream 490 corresponding to the first downlink packet to the cellular modem circuit 420. The modules 445 demodulate the digital stream, reconstruct a frame from the digital stream, and de-capsulate the frame to extract the first downlink packet 491. The baseband processing circuit 440 then performs the IP layer protocol 444 on the first downlink packet 491.

In an embodiment, the baseband processing circuit 440 extracts a first header characteristic of the first downlink packet 491, searches a lookup table of modification rules for a modification rule with matching header characteristic to the first header characteristic. When the baseband processing circuit 440 fails to find, in the lookup table, the modification rule for the first header characteristic, the baseband processing circuit 440 provides the first downlink packet 491 to the application processor 470 via the DMA circuit 471.

Then the application processor 470 performs routing and network address translation on the first downlink packet to generate a modified first downlink packet. For example, the application processor 470 changes the destination IP address field, and the destination port field. The application processor 470 provides the modified first downlink packet 493 to the cellular modem circuit 420 via the DMA circuit 471.

When the cellular modem circuit 420 receives the modified first downlink packet, the baseband processing circuit 440 compares the modified first downlink packet with the first downlink packet to determine first modification, such as the destination IP address change, the destination port change, and the like. The baseband processing circuit 440 stores a first modification rule that associates the first modification with the first header characteristic. The modified first downlink packet is further processed. For example, the modulated first downlink packet is encapsulated in a frame, and the frame is converted into digital signals for USB transmission. The USB interface 460 transmits signals 495 that carry the modified first downlink packet.

Further, in the FIG. 4 example, the transceiver circuit 450 receives signals carrying a second downlink packet. The transceiver circuit 450 provides a digital stream 496 corresponding to the second downlink packet to the cellular modem circuit 420. The modules 445 demodulates the digital stream, reconstruct a frame, and de-capsulate the frame to extract the second downlink packet 497. The baseband processing circuit 440 then performs the IP layer protocol 444 on the second downlink packet 497.

In an embodiment, the baseband processing circuit 440 extracts a second header characteristic of the second downlink packet 497, searches the lookup table of modification rules for a modification rule with matching head characteristic to the second header characteristic. When the baseband processing circuit 440 finds that the first modification rule has matching header characteristic to the second header characteristic, the baseband processing circuit 440 applies the first modification on the second downlink packet to generate a modified second downlink packet 498. The modified second downlink packet is further processed. For example, the modulated second downlink packet is encapsulated in a frame, and the frame is converted into digital signals for USB transmission. The USB interface 460 transmits signals 499 that carry the modified second downlink packet.

In the FIG. 4 example, the second down packet is directly routed with NAT by the cellular modem circuit 420. In an example, the application processor 470 can stay in the power saving mode, and does not need to wake up to process the second downlink packet.

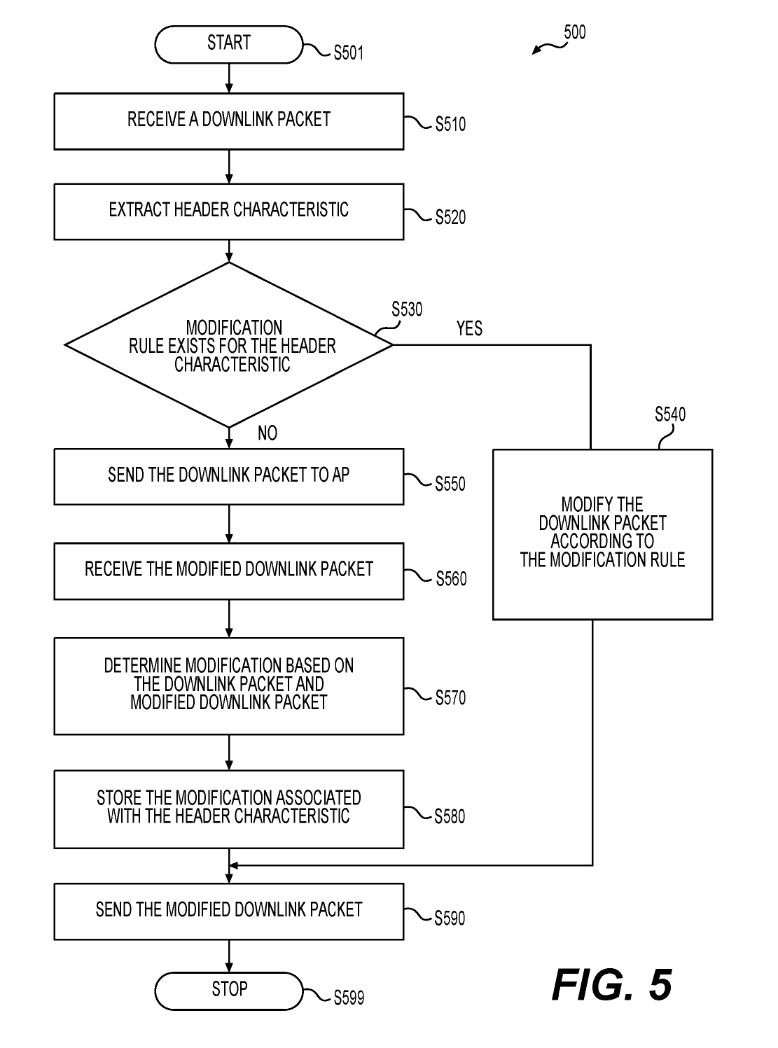

FIG. 5 shows a flow chart outlining a process 500 for handling downlink communication according to an embodiment of the disclosure. In an example, the process 500 is executed by the electronic device 410 in the FIG. 4 example. The process starts at S501, and proceeds to S510.

At S510, a downlink packet is received. In an example, the baseband processing circuit 440 reconstructs the downlink packet from signals received by the transceiver circuit 450.

At S520, a header characteristic is extracted. In an example, the baseband processing circuit 440 parses the downlink packet to extract, for example, one or more of the source IP address field, the source port field, the destination IP address field, the destination port field and the like.

At S530, the baseband processing circuit 440 determines whether a modification rule exists for the header characteristic. When the modification rule exists, the process proceeds to S540; otherwise, the process proceeds to S550.

At S540, the downlink packet is modified according to the modification rule. For example, the modification rule includes a modification associated with the header characteristic. the baseband processing circuit 440 applies the modification to the downlink packet to generate the modified downlink packet.

At S550, the downlink packet is provided to another processing unit, such as the application processor 470. In an example, the application processor 470 performs routing and network address translation on the downlink packet to generate a modified downlink packet.

At S560, the modified downlink packet is received. In an example, the application processor 470 provides the modified downlink packet to the baseband processing circuit 440.

At S570, a modification is determined based on the downlink packet and the modified downlink packet. In an example, the baseband processing circuit 440 compares the downlink packet and the modified downlink packet to determine changes, such as IP address change, port change, and the like from the downlink packet to the modified downlink packet.

At S580, the modification is stored in association with the header characteristic. In an example, the baseband processing circuit 440 stores a modification rule that associates the modification with the header characteristic in the look-up table.

At S590, the modified downlink packet is transmitted. For example, the modulated downlink packet is encapsulated in a frame, and then is converted into suitable form for USB transmission. The USB interface 460 then transmits signals carrying the modified downlink packet. Then, the process proceeds to S599 and terminates.

When implemented in hardware, the hardware may comprise one or more of discrete components, an integrated circuit, an application-specific integrated circuit (ASIC), etc.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. An electronic device, comprising:
a transceiver circuit configured to transmit and receive wireless signals to/from a first network that uses a first network address space;
an interface circuit configured to interconnect the electronic device with one or more devices to form a second network using a second network address space; and
a modulator-demodulator (modem) circuit coupled to the transceiver circuit to modulate/demodulate signals for wireless communication, the modem circuit being configured to:
provide a packet of a header characteristic for a network address translation between the first network address space and the second network address space;
receive, after the network address translation, a modified packet corresponding to the packet;
determine a modification associated with the header characteristic; and
apply the modification to one or more other packets having the header characteristic.

2. The electronic device of claim 1, wherein the electronic device is assigned a first network address in the first network address space for communication in the first network and is assigned a second network address for communication in the second network.

3. The electronic device of claim 2, wherein the modem circuit is configured to:
provide a first uplink packet that is received from the interface circuit for the network address translation;
receive a modified first uplink packet corresponding to the first uplink packet;
determine a source address change and a source port change in an Internet protocol (IP) header; and
store the source address change and the source port change associated with the header characteristic.

4. The electronic device of claim 2, wherein the modem circuit is configured to:
provide a first downlink packet that is received from the transceiver circuit for the network address translation;
receive a modified first downlink packet corresponding to the first downlink packet;
determine a destination address change and a destination port change in an Internet protocol (IP) header; and
store the destination address change and the destination port change associated with the header characteristic.

5. The electronic device of claim 1, wherein the modem circuit is configured to provide the packet of the header characteristic to an application processor for the network address translation.

6. The electronic device of claim 5, wherein the modem circuit is configured to receive a tagged packet from the application processor, and receive a tracking of pre-processing and post-processing of the tagged packet to determine the modification by the application processor.

7. The electronic device of claim 5, wherein the modem circuit is configured to tag the packet before the network address translation and receive a modified packet corresponding to the tagged packet after the network address translation.

8. The electronic device of claim 1, wherein the interface circuit is configured according to a universal serial bus (USB) standard.

9. The electronic device of claim 1, wherein the interface circuit is configured according to a WiFi standard.

10. The electronic device of claim 1, wherein the modem circuit is configured to perform the network address translation.

11. A method for communication, comprising:
receiving, by a modulator-demodulator (modem) circuit in an electronic device, a packet of a header characteristic for transmission between a first network using a first network address space and a second network using a second address space, the electronic device including a transceiver circuit that is coupled to the first network, and an interface circuit that is coupled to the second network;
performing a network address translation on the packet for routing the packet;
determining a modification on the packet due to the network address translation; and
applying the modification to one or more other packets having the header characteristic.

12. The method of claim 11, further comprising:
using a first network address in the first network address space for communication in the first network; and
using a second network address in the second network address space for communication in the second network.

13. The method of claim 12, wherein determining the modification on the packet due to the network address translation further comprises:
determining a source address change and a source port change in an Internet protocol (IP) header of the packet when the packet is an uplink packet that is received from the interface circuit and is for transmission by the transceiver circuit; and
storing the source address change and the source port change associated with the header characteristic.

14. The method of claim 12, wherein determining the modification on the packet due to the network address translation further comprises:
determining a destination address change and a destination port change in an Internet protocol (IP) header of the packet when the packet is a downlink packet that is received from the transceiver circuit and is for transmission by the interface circuit; and
storing the destination address change and the destination port change associated with the header characteristic.

15. The method of claim 11, wherein performing the network address translation on the packet for routing the packet further comprises:
providing the packet of the header characteristic to an application processor for the network address translation.

16. The method of claim 15, further comprising:
receiving a tagged packet from the application processor; and
receiving a tracking of pre-processing and post-processing of the tagged packet for determining the modification.

17. The method of claim 15, further comprising:
tagging the packet before the network address translation; and
receiving a modified packet corresponding to the tagged packet after the network address translation.

18. The method of claim 11, wherein
transmitting/receiving packets, by the interface circuit, according to a universal serial bus (USB) standard.

19. The method of claim 11, wherein
Transmitting/receiving packets, by the interface circuit, according to a WiFi standard.

20. The method of claim 11, wherein performing the network address translation on the packet for routing the packet further comprises:
performing, by the modem circuit, the network address translation to route the packet.
